(19) United States
(12) Patent Application Publication
(10) Pub. No.: US 2018/0176524 A1
(43) Pub. Date: Jun. 21, 2018

(54) LASER PROJECTION DISPLAY DEVICE

(71) Applicant: Hitachi-LG Data Storage, Inc., Tokyo (JP)

(72) Inventors: Tomoki KOBORI, Tokyo (JP); Tatsuya YAMASAKI, Tokyo (JP); Junji NAKAJIMA, Tokyo (JP); Katsuhiko KIMURA, Tokyo (JP); Takanori AONO, Tokyo (JP)

(21) Appl. No.: 15/790,228

(22) Filed: Oct. 23, 2017

(30) Foreign Application Priority Data
Dec. 20, 2016 (JP) 2016-246586

(51) Int. Cl. H04N 9/31; G02B 27/01

(52) U.S. Cl. CPC H04N 9/3194; H04N 9/3135; G02B 2027/014; G02B 27/0101; H04N 9/3144

(57) ABSTRACT

The laser projection display device includes a scanning mirror reflecting and two-dimensionally scanning a laser beam emitted from a laser light source and sensors detecting rotation angles of the scanning mirror, and controls driving of the scanning mirror on the basis of sensor signals output from the sensors. At this time, a temperature compensation unit compensates for temperature dependency of a transfer characteristic of a signal transmission line for transmitting the sensor signals according to a temperature measured by a thermometer arranged in the vicinity of the scanning mirror. In order to correct amplitudes and phases of the rotation angles of the scanning mirror obtained from the sensor signal, the temperature compensation unit includes a look-up table storing correction amounts for each temperature.

### CLAIM OF PRIORITY

The present application claims priority from Japanese patent application serial No. JP 2016-246586, filed on Dec. 20, 2016, the content of which is hereby incorporated by reference into this application.

### BACKGROUND OF THE INVENTION

### (1) Field of the Invention

The present invention relates to a laser projection display device for performing image display by two-dimensionally scanning a laser beam with a scanning mirror.

### (2) Description of the Related Art

In recent years, laser projection display devices for projecting an image using a semiconductor laser, a MEMS (Micro Electro Mechanical Systems) mirror, or the like have been put to practical use. In the laser projection display device, a desired image is displayed on a projection surface by scanning with the scanning mirror horizontally and vertically and simultaneously modulating a laser light source. At this time, since there is temperature dependency in mechanical characteristics of the mirror, a configuration for controlling driving conditions of the mirror according to an ambient temperature has been proposed (for example, refer to JP 2015-028596 A).

### SUMMARY OF THE INVENTION

In JP 2015-028596 A, the ambient temperature is calculated from resonance frequency of the mirror, and a driving signal (phase difference between two cantilevers) of the mirror is adjusted on the basis of the calculated ambient temperature. Therefore, it has been proposed to compensate for the temperature dependency of the mechanical characteristics of the mirror.

However, the inventor of the present invention found that the compensation for the temperature dependency of the mechanical characteristics of the mirror alone is insufficient to display a stable image. Namely, it has been found that, when a rotation angle of the mirror is detected by a sensor and a detected mirror signal is transmitted to a control circuit to generate the driving signal for the mirror, temperature dependency of a signal transmission line from the sensor to the control circuit also influences the display image. Namely, as a transfer characteristic of the signal transmission line changes in temperature, amplitude and phase information of the mirror rotation angle are not fed back accurately, which causes distortion and positional shift in the display image. Therefore, it is necessary to perform temperature compensation not only on the temperature dependency of the mechanical characteristics of the mirror but also on the temperature dependency of the transfer characteristic of the mirror rotation angle signal. Such a problem has not been recognized in the related art such as in JP 2015-028596 A.

The present invention is to provide a laser projection display device which displays an image with higher accuracy by compensating for temperature dependency of a transmission line of a mirror rotation angle signal.

According to the present invention, there is provided a laser projection display device projecting a laser beam according to an image signal to display an image, including: a laser light source emitting the laser beam; a light source driving unit driving the laser light source; an image processing unit supplying the image signal for display to the light source driving unit; a scanning mirror reflecting and two-dimensionally scanning the laser beam emitted from the laser light source; a mirror driving unit supplying a driving signal for rotating the scanning mirror in two axial directions; a sensor detecting a rotation angle of the scanning mirror; a system control unit controlling the image processing unit and the mirror driving unit on the basis of a sensor signal output from the sensor; and a temperature compensation unit compensating for temperature dependency of a transfer characteristic of a signal transmission line for transmitting the sensor signal according to a temperature measured by a thermometer arranged in the vicinity of the scanning mirror.

According to the present invention, since a rotation angle signal of the mirror is accurately transmitted even if a temperature changes, it is possible to provide a laser projection display device which displays an image with higher accuracy.

### BRIEF DESCRIPTION OF THE DRAWINGS

FIG. 1 is a diagram illustrating an overall configuration of a laser projection display device.

FIG. 2 is a diagram illustrating a configuration of a MEMS.

FIG. 3 is a diagram illustrating temperature dependency of the frequency characteristic of a MEMS.

FIG. 4 is a diagram illustrating an internal configuration of a temperature compensation unit.

FIG. 5 is a diagram illustrating temperature compensation of a MEMS scanning signal with signal waveforms.

FIGS. 6A to 6C are diagrams illustrating effects of temperature compensation with display images.

FIG. 7 is a diagram illustrating a configuration of a head-up display (HUD).

### DETAILED DESCRIPTION OF THE EMBODIMENT

Hereinafter, embodiments of the present invention will be described in detail with reference to the drawings. In addition, the following description is provided for explaining one embodiment of the present invention and does not limit the scope of the present invention.

### First Embodiment

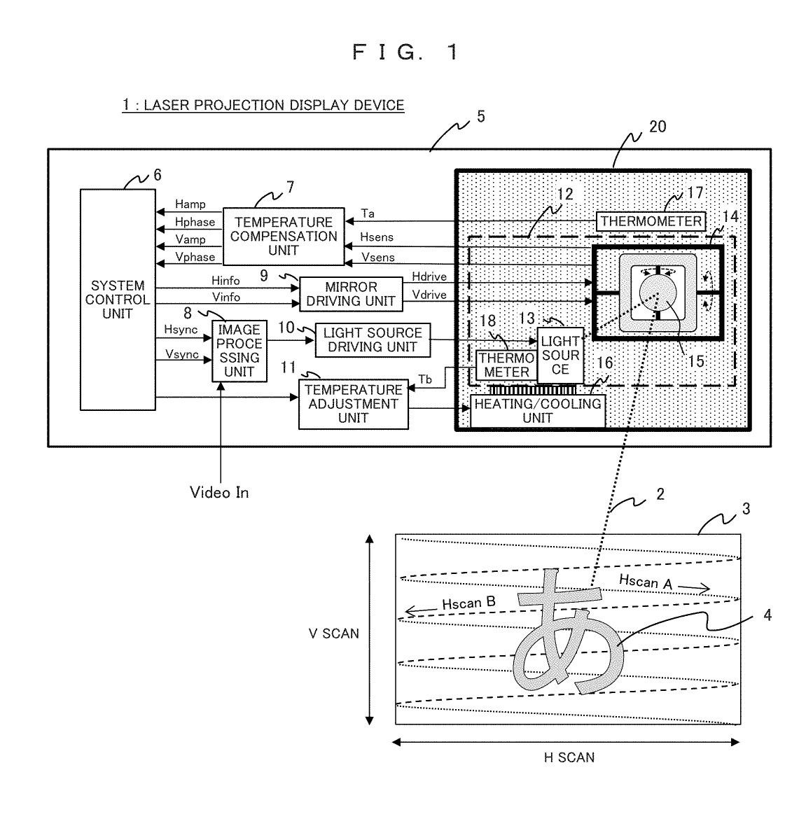

FIG. 1 is a diagram illustrating an overall configuration of a laser projection display device. A system control unit 6, a temperature compensation unit 7, an image processing unit 8, a mirror driving unit 9, a light source driving unit 10, and a temperature adjustment unit 11 are included as a control system in a casing 5 of a laser projection display device 1 (hereinafter, also simply referred to as a display device). In addition, a laser light source 13 (hereinafter, simply referred to as a light source), a micro electro mechanical system (MEMS) 14, a scanning mirror (hereinafter, also simply referred to as a mirror) 15, a heating/cooling unit 16, and thermometers 17 and 18 are included as a projection module 12. The projection module 12 and the heating/cooling unit 16 are accommodated in a housing 20 having a hermetic structure. The display device 1 displays an image 4 by projecting a laser beam 2 on a display area 3 and performing two-dimensional scanning in the horizontal direction and the vertical direction. Hereinafter, operations of each unit will be described.

The system control unit 6 transmits horizontal driving information (Hinfo) and vertical driving information (Vinfo) to the mirror driving unit 9. These pieces of driving information include information on frequency, amplitude, and phase for performing horizontal/vertical scanning of the mirror. The mirror driving unit 9 generates a sinusoidal horizontal driving signal (Hdrive) and a saw-tooth wave vertical driving signal (Vdrive) according to the horizontal driving information (Hinfo) and the vertical driving information (Vinfo), and supplies the driving signals to the MEMS 14. Accordingly, the scanning mirror 15 of the MEMS 14 performs swinging rotation around the horizontal axis and the vertical axis.

In the MEMS 14, the rotation angles of the horizontal axis and the vertical axis of the scanning mirror 15 are detected by a sensor (distortion sensor) and transmitted to the temperature compensation unit 7 as sensor signals (Hsens, Vsens). In addition, the thermometer 17 is arranged in the vicinity of the MEMS 14 to measure a temperature (inside air temperature) Ta in the vicinity of the MEMS and transmit the measured temperature to the temperature compensation unit 7. The temperature compensation unit 7 obtains an amplitude (Hamp, Vamp) and a phase (Hphase, Vphase) of the mirror rotation angles from the sensor signals (Hsens, Vsens) and transmits the amplitude and phase of the mirror rotation angles to the system control unit 6. At this time, the temperature compensation unit 7 compensates for the temperature dependency of the transfer characteristic of the sensor signal transmission line by the inside air temperature Ta inside the housing 20 measured by the thermometer 17.

The image processing unit 8 generates an image signal for projection by applying various corrections to an image signal (Video In) input from the outside, and temporarily stores the image signal in a frame memory (not shown). The corrections performed herein include image distortion correction accompanying the scanning of the scanning mirror 15, image gradation adjustment, and the like. On the other hand, the system control unit 6 transmits a horizontal synchronization signal (Hsync) and a vertical synchronization signal (Vsync) to the image processing unit 8 in synchronization with the mirror rotation. The image processing unit 8 reads the image signal from the frame memory in synchronization with the synchronization signals (Hsync, Vsync) and supplies the image signal to the light source driving unit 10.

The light source driving unit 10 modulates a driving current of the laser light source 13 according to the image signal supplied from the image processing unit 8. The light source 13 has, for example, three semiconductor lasers for RGB and emits a laser beam corresponding to RGB components of the image signal. The three laser beams of RGB are combined by a dichroic mirror (not shown), and the scanning mirror 15 is irradiated with the combined laser beam of RGB.

The laser beam 2 emitted from the light source 13 is reflected by the scanning mirror 15 swinging and rotating around the horizontal axis and the vertical axis, so that the display area 3 is two-dimensionally scanned to draw the image 4. Scanning in the horizontal direction is drawn by reciprocating scanning (HscanA, HscanB).

Since the light source 13 in operation is at a high temperature, the light source is heated or cooled by the heating/cooling unit 16. As a heating/cooling element, a Peltier element, a heater or the like is used. The thermometer is arranged in the vicinity of the light source 13 to measure the light source temperature Tb and transmit the measured light source temperature to the temperature adjustment unit 11. The temperature adjustment unit 11 compares a target temperature given from the system control unit 6 with the light source temperature Tb from the thermometer 18 and drives the heating/cooling unit 16.

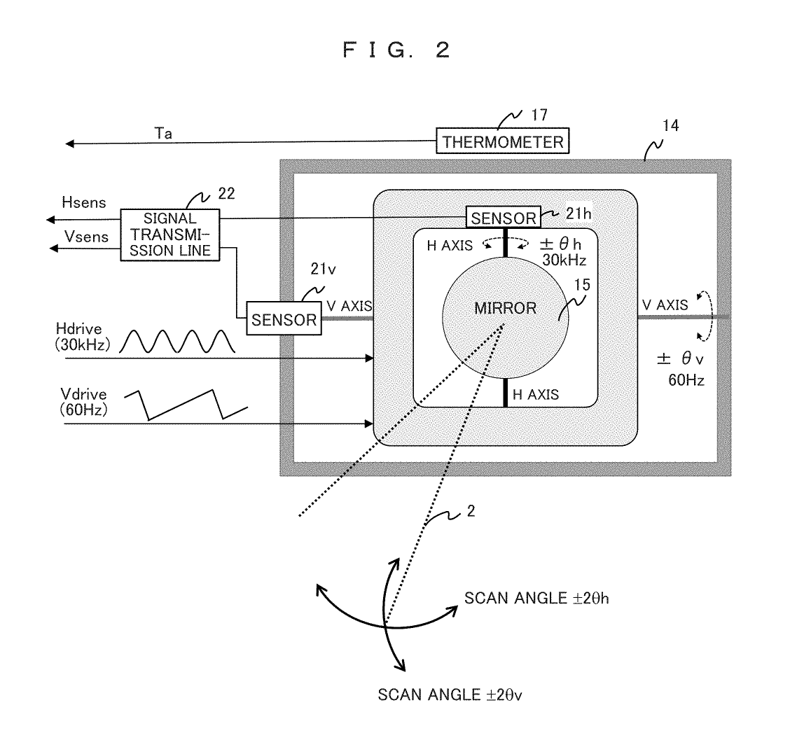

FIG. 2 is a diagram illustrating a configuration of the MEMS 14. The MEMS 14 has rotation mechanisms of two axes (H axis, V axis) and scans the display image with the scanning mirror 15. By the driving signals (Hdrive, Vdrive) from the mirror driving unit 9, the mirror 15 is swung and rotated in two directions of the horizontal direction (around H axis) and the vertical direction (around V axis). For example, the mirror is driven with a sine wave of 30 kHz in the horizontal direction and a sawtooth wave of 60 Hz in the vertical direction. Assuming that the rotation angles (swing angles) in the horizontal direction and the vertical direction of the mirror 15 is ±θh and ±θv, respectively, the scan angles of the reflected laser beam 2 on the display area 3 become ±2θh and ±2θv, respectively, which are twice the rotation angles.

Sensors 21h and 21v for detecting the respective rotation angles are attached to the H axis and the V axis of the MEMS 14. The sensors (21h, 21v) generate signals (Hsens, Vsens) (hereinafter, referred to as sensor signals) indicating the rotation angles of the mirror from distortion occurring on the H axis and the V axis and transmits the sensor signals through the temperature compensation unit 7 to the system control unit 6. The sensor signals (Hsens, Vsens) are interlocked with the driving signals (Hdrive, Vdrive). However, since the mechanical characteristics of the mirror change in ambient temperature and ambient pressure, the correlation between amplitude and phase is collapsed. Therefore, the system control unit 6 feeds back the actual rotation state of the mirror and corrects the driving information (Hinfo, Vinfo) to be transmitted to the mirror driving unit 9 so as to be in a predetermined rotation state.

In addition, the signal transmission line 22 for transmitting the sensor signal (Hsens, Vsens) is configured with a wiring pattern, a relay cable, and a processing circuit (not shown). However, values of wiring resistance and inter-line capacitance included therein change in the ambient temperature. Since the sensors 21h and 21v are also configured with a resistance bridge circuit, the values are also influenced by a temperature characteristic of the sensor resistance. As a result, the transfer characteristic of the sensor signals (Hsens, Vsens) transmitted from the sensors 21h, 21v change.

Therefore, in the embodiment, the thermometer 17 and the temperature compensation unit 7 are provided. The thermometer 17 is arranged in the vicinity of the MEMS 14 in a non-contact state. The reason for arranging in a non-contact state is to avoid thermal conduction with the MEMS 14, so that it is possible to obtain an environment close to the temperature environment of the signal transmission line 22 in the housing 20. The inside air temperature Ta measured by the thermometer 17 is transmitted to the temperature compensation unit 7, and the temperature compensation unit 7 compensates for the transfer characteristic of the signal transmission line 22 according to the inside air temperature Ta. Specifically, the temperature compensation unit corrects the amplitude and phase of the mirror rotation obtained from the sensor signals (Hsens, Vsens) and transmits the corrected amplitude and phase of the mirror rotation to the system control unit 6.

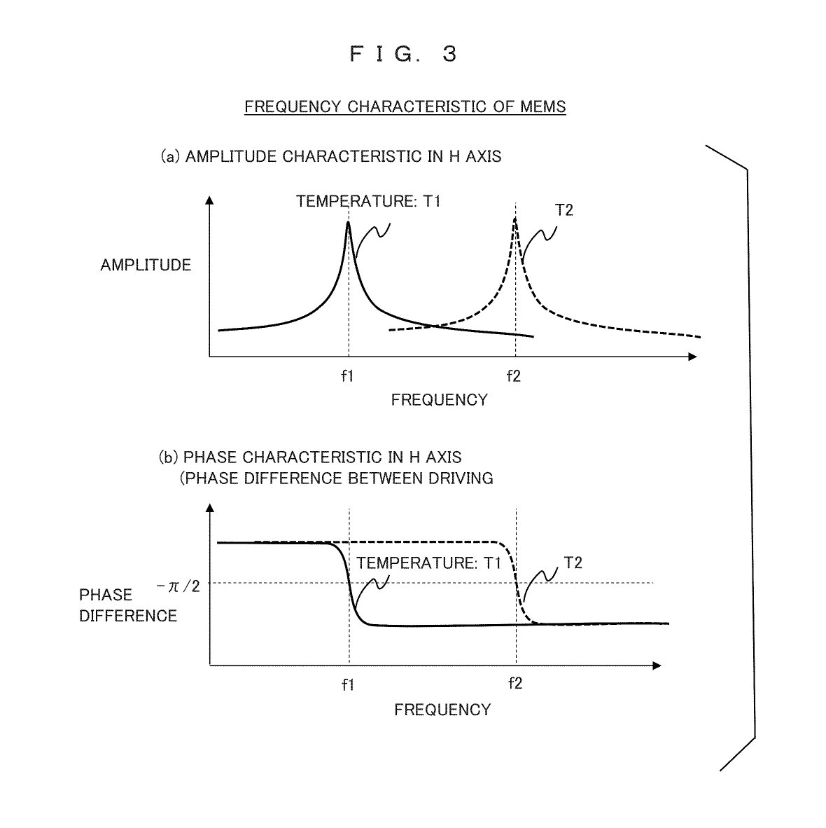

FIG. 3 is a diagram illustrating temperature dependency of a frequency characteristic of the MEMS 14. (a) illustrates the amplitude characteristic on the H axis according to the frequency on the horizontal axis. If the ambient temperature changes from T1 to T2 (T1<T2), a resonance frequency of the mirror changes from f1 to f2 (f1<f2). (b) Illustrates a phase characteristic of the H axis according to the frequency on the horizontal axis. Herein, the phase characteristic represents a phase difference between a driving signal and a deflection angle (rotation angle) of the mirror. If the ambient temperature changes from T1 to T2, the phase difference (lead/lag) is switched as interlocked with the resonance frequencies f1 and f2 at the respective temperatures.

Such a change in the frequency characteristic of the MEMS is caused by the temperature dependency of the mechanical characteristics of the mirror. Besides, the mechanical characteristics of the mirror are also influenced by the ambient pressure (air density). The system control unit 6 corrects the driving information (Hinfo, Vinfo) to be supplied to the mirror driving unit 9 so as to have a predetermined amplitude and phase on the basis of the rotation angle signals of the mirror detected by the sensors 21h and 21v. Therefore, it is possible to remove fluctuation of the characteristics of the MEMS due to the change in the ambient temperature or the atmospheric pressure.

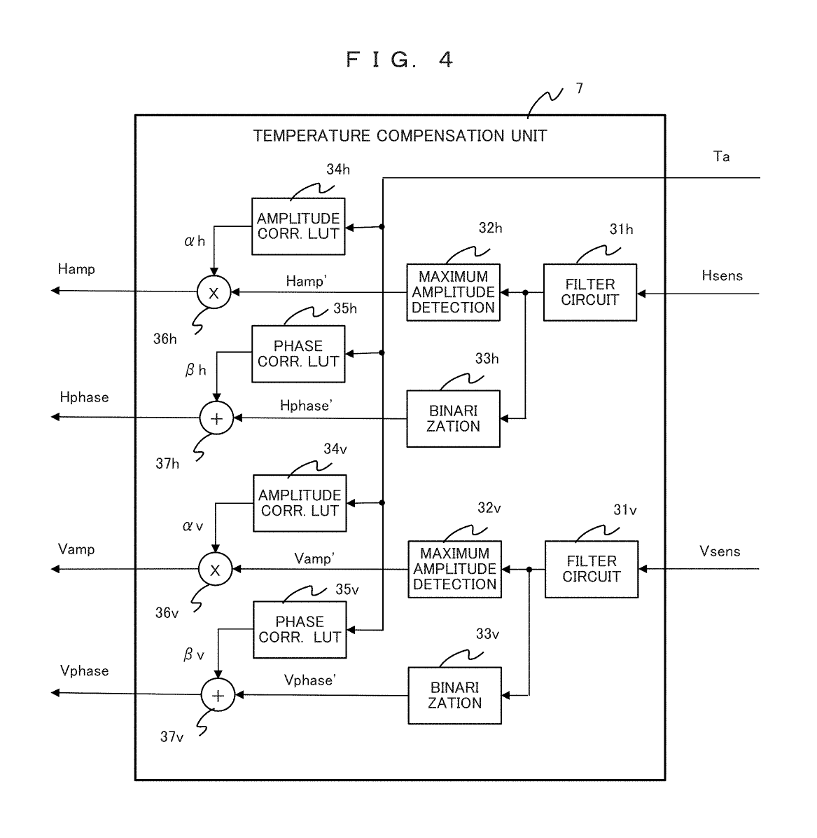

FIG. 4 is a diagram illustrating an internal configuration of the temperature compensation unit 7. The inside air temperature Ta from the thermometer 17 and the sensor signals (Hsens, Vsens) from the sensors 21h and 21v are input to the temperature compensation unit 7. The temperature compensation unit 7 performs temperature compensation processing according to the temperature Ta to calculate the amplitude (Hamp, Vamp) and the phase (Hphase, Vphase) of the mirror, and outputs the calculated amplitude and phase of the mirror to the system control unit 6. Processing of these signals will be described.

A filter circuit 31h removes a noise signal from the sensor signal (Hsens) on the H axis, and after that, a maximum amplitude detection circuit 32h detects a maximum amplitude (Hamp′) of the mirror rotation angle. In addition, a binarization circuit 33h detects a phase difference (Hphase′) with respect to the driving signal by obtaining a zero crossing point. Next, the temperature compensation is performed. The transfer characteristic of the signal transmission line 22 for each temperature Ta is measured in advance, and the compensation amounts thereof, namely an amplitude correction amount αh and a phase correction amount βh, are stored in an amplitude correction LUT (look-up table) 34h and a phase correction LUT 35h.

A multiplier 36h multiplies the maximum amplitude (Hamp′) detected by the maximum amplitude detection circuit 32h by the correction amount αh read out from the amplitude correction LUT 34h and transmits the compensated maximum amplitude (Hamp) to the system control unit 6. On the other hand, an adder 37h adds (subtracts) the correction amount βh read out from the phase correction LUT 35h to the phase difference (Hphase′) detected by the binarization circuit 33h and transmits the compensated phase difference (Hphase) to the system control unit 6.

Similarly to the H-axis, a processing circuit is also provided to the V-axis sensor signal (Vsens), a multiplier 36v transmits a maximum amplitude (Vamp) after compensation to the system control unit 6, and an adder 37v transmits a phase difference (Vphase) after compensation to the system control unit.

By the above-described temperature compensation processing, the temperature change in the transfer characteristic of the sensors 21h and 21v in the signal transmission line 22 is corrected. The information of the rotation angles of the mirror detected by the sensors 21h and 21v can be reliably transmitted to the system control unit 6. Therefore, in the system control unit 6, the driving information (Hinfo, Vinfo) supplied to the mirror driving unit 9 and the synchronization signals (Hsync, Vsync) supplied to the image processing unit 8 become accurate, and thus, the accuracy of the displayed image is improved.

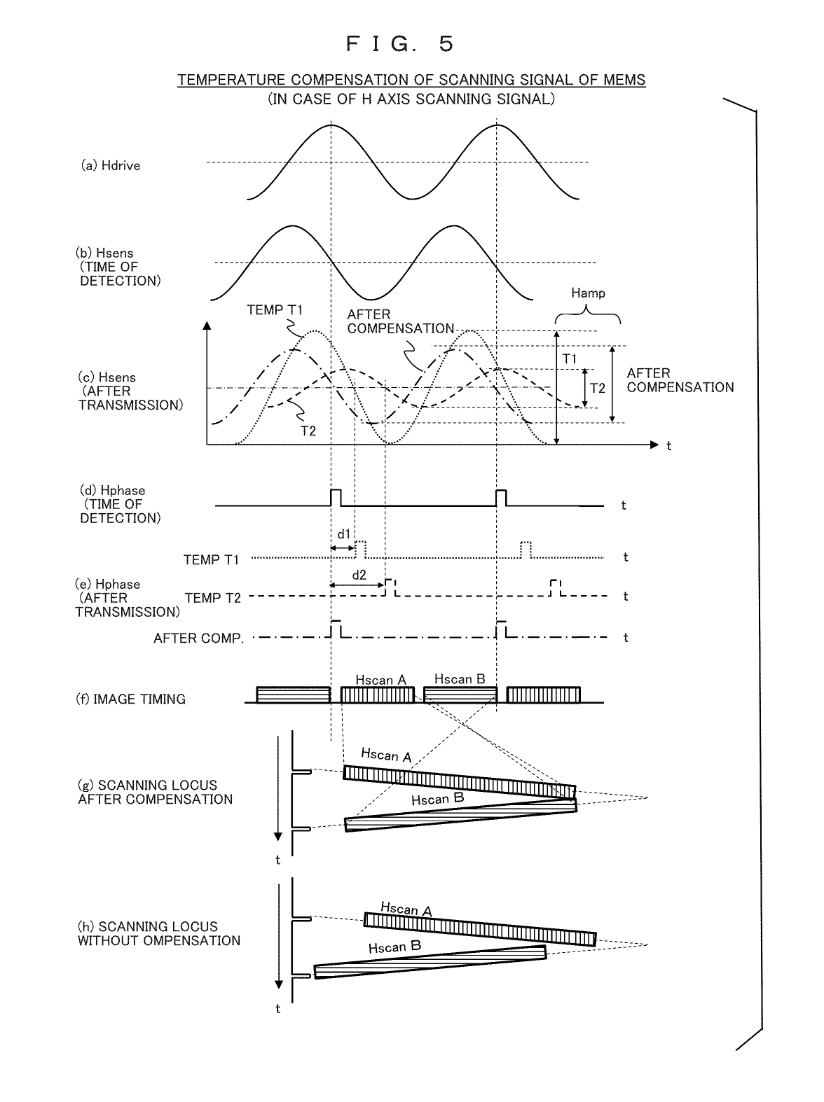

FIG. 5 is a diagram illustrating the temperature compensation of the MEMS scanning signal with signal waveforms. Herein, the H-axis scanning signal is illustrated.

(a) illustrates the H-axis driving signal (Hdrive), and (b) illustrates the H-axis rotation angle signal (Hsens) of the scanning mirror 15 at the time of detection by the sensor 21h. In this manner, the sensor signal (Hsens) has a relationship that the phase is shifted by approximately π/2 from the driving signal (Hdrive).

(c) Illustrates waveforms of the sensor signal (Hsens) after transmission to the temperature compensation unit 7. Since the transfer characteristic of the transmission line 22 from the sensor 21h to the temperature compensation unit 7 varies with the inside air temperature, the amplitude and phase of the sensor signal (Hsens) transmitted to the temperature compensation unit 7 are changed in comparison with the waveforms at the time of detection in (b). Herein, an example of the change at the two temperatures T1 and T2 is illustrated.

As illustrated in FIG. 4, the temperature compensation unit 7 refers to the lookup tables 34h and 35h and applies the amplitude correction an and the phase correction βh according to the temperatures T1 and T2. As a result, the amplitude Hamp of the transmitted sensor signal (Hsens) is corrected, and the value at the time of detection in (b), that is, the true value is restored.

(d) illustrates a position of the zero cross point of the sensor signal (Hsens) at the time of detection illustrated in (b), that is, the phase (Hphase). (e) illustrates the phase (Hphase) of the sensor signal (Hsens) after transmission illustrated in (c), and transmission delays d1 and d2 occur at temperatures T1 and T2 due to the temperature change in the transfer characteristic of the transmission line 22. In the temperature compensation unit 7, by applying the phase correction βh according to the temperatures T1 and T2, the value for the phase (Hphase) after transmission at the time of detection in (d), namely, the true value is restored.

(f) illustrates an output timing of an image signal from the image processing unit 8, and supplying the image is performed corresponding to the reciprocating scanning (HscanA, HscanB) in the H direction illustrated in FIG. 1. (g) Illustrates a scanning locus after temperature compensation. Since the drawing start/end positions of the reciprocating scanning (HscanA, HscanB) are aligned in the vertical direction, the image to be displayed is not shifted in the horizontal direction between the adjacent scanning lines. On the other hand, (h) illustrates the scanning locus without temperature compensation for comparison. Since the phase delays d1 and d2 occur on the transmission line, the drawing start/end positions of the reciprocating scanning (HscanA, HscanB) are not aligned in the vertical direction. Therefore, in the displayed image, a shift in the horizontal direction occurs between the adjacent scanning lines.

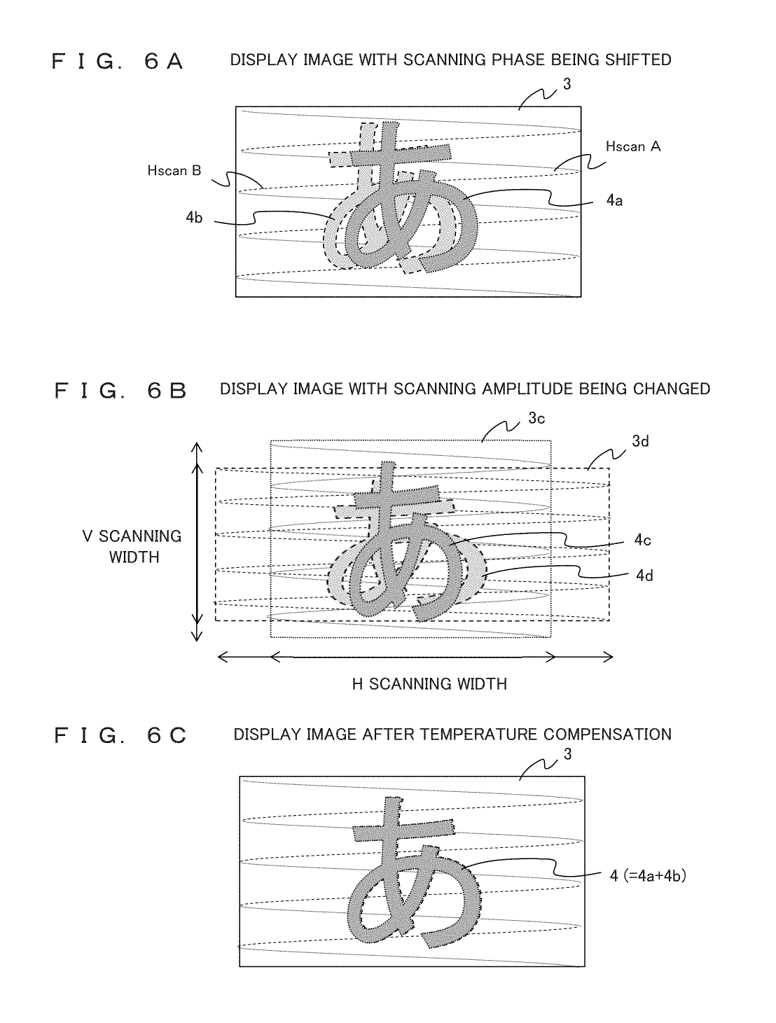

FIGS. 6A to 6C are diagrams illustrating effects of temperature compensation with display images.

FIG. 6A illustrates a display image when the scanning phase is shifted without temperature compensation. As described with reference to FIG. 5(h), since the drawing start/end positions of the image in the reciprocating scanning (HscanA, HscanB) are not aligned in the vertical direction, phase shift in the horizontal direction is generated in the images 4a and 4b drawn by reciprocating scanning, and a double image is displayed.

FIG. 6B illustrates a display image when the scanning amplitude changes without temperature compensation. The H scanning width or the V scanning width is expanded and contracted, and thus, the display area is deformed like 3c and 3d. As a result, the image to be drawn becomes an image distorted in the vertical direction or the horizontal direction like 4c and 4d. In addition, since the display area is changed, the brightness of the display screen is also changed.

FIG. 6C illustrates a display image where the scanning phase and the scanning amplitude are corrected by temperature compensation. Since the drawing start/end positions of the images in the reciprocal scanning (HscanA, HscanB) are aligned in the vertical direction, the phases of the images 4a and 4b drawn by the reciprocating scanning are aligned, and the images 4 are displayed as one image 4. Also, since the H scan width and V scan width are constant, the display area is not changed, and the brightness of the display screen is constant.

As described above, according to the first embodiment, even if the characteristics of the transmission line 22 for transmitting the detection signal of the rotation angle of the mirror is changed due to the change of the inside air temperature in the housing, the temperature compensation unit can perform compensation processing on the amplitude and phase. Therefore, the driving information supplied from the system control unit 6 to the mirror driving unit 9 and the synchronization signal supplied to the image processing unit 8 become accurate, and thus, there is an effect of improving the accuracy of the image to be displayed.

### Second Embodiment

In the second embodiment, a head-up display (HUD) having the laser projection display device described in the first embodiment will be described. Herein, an example where a head-up display (HUD) is mounted on a vehicle to display information for driving assistance is displayed will be described.

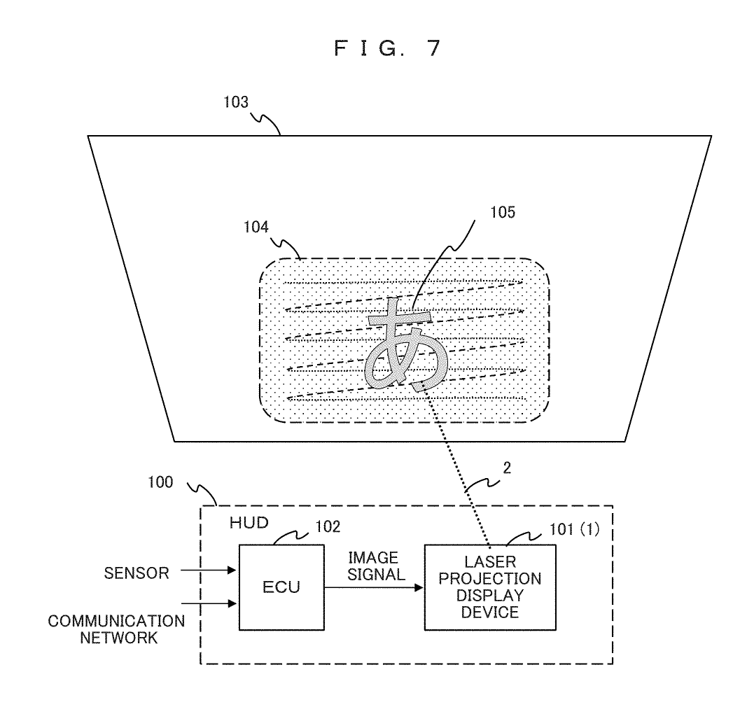

FIG. 7 is a diagram illustrating a configuration of the HUD. The HUD 100 is configured to include a laser projection display device 101 (corresponding to reference numeral 1 in FIG. 1) and an electronic control unit (ECU) 102. The ECU 102 inputs detection information of various sensors in the vehicle to display information acquired via a communication network. For example, speed information, gear information, GPS information and the like indicating a driving state of the vehicle are included. Based on the input information, the ECU 102 generates an image signal including information to be provided to the driver and outputs the generated image signal to the laser projection display device 101. At this time, the information to be supplied is selected in accordance with the driving state and the running state of the vehicle, and the level of the image signal (the brightness of the display image) is adjusted according to the brightness of the external light.

As described in the first embodiment, the laser projection display device 101 projects a laser beam 2 corresponding to the image signal toward a front windshield 103 of the vehicle and scans the laser beam in two dimensions. A combiner 104 made of a semi-transmissive reflective material is attached to an inner surface of the windshield 103, and a virtual image 105 is displayed by projecting the laser beam 2 on the combiner 104.

In the in-vehicle HUD, a range of change in the ambient temperature is large, and the temperature environment becomes severe. However, as described in the first embodiment, by performing temperature compensation of the signal transmission line of the laser projection display device 101, it is possible to display a stable image.

What is claimed is:

1. A laser projection display device projecting a laser beam according to an image signal to display an image, comprising:
a laser light source emitting the laser beam;
a light source driving unit driving the laser light source;
an image processing unit supplying the image signal for display to the light source driving unit;
a scanning mirror reflecting and two-dimensionally scanning the laser beam emitted from the laser light source;
a mirror driving unit supplying a driving signal for rotating the scanning mirror in two axial directions;
a sensor detecting a rotation angle of the scanning mirror;
a system control unit controlling the image processing unit and the mirror driving unit on the basis of a sensor signal output from the sensor; and
a temperature compensation unit compensating for temperature dependency of a transfer characteristic of a signal transmission line for transmitting the sensor signal according to a temperature measured by a thermometer arranged in the vicinity of the scanning mirror.

2. The laser projection display device according to claim 1,
wherein the laser light source, the scanning mirror, and the sensor are accommodated in a housing having a hermetic structure, and
wherein the thermometer measures a temperature of a space inside the housing in the vicinity of the scanning mirror.

3. The laser projection display device according to claim 1,
wherein the temperature compensation unit corrects an amplitude and a phase of the rotation angle of the scanning mirror obtained from the sensor signal and includes a look-up table storing correction amount of the amplitude and the phase for each temperature.

4. The laser projection display device according to claim 1, further comprising:
a heating/cooling unit heating or cooling the laser light source; and
a temperature adjustment unit driving the heating/cooling unit so that a temperature in the vicinity of the laser light source becomes a target temperature.

5. A head-up display comprising the laser projection display device according to claim 1, comprising:
an electronic control unit generating an image signal to be displayed on the basis of input information, adjusting a level of the image signal, and outputting the image signal to the laser projection display device,
wherein the laser projection display device projects the laser beam corresponding to the image signal to display the image.
